(19) United States
(12) Patent Application Publication
(10) Pub. No.: US 2006/0256060 A1
(43) Pub. Date: Nov. 16, 2006

(54) Drive apparatus and printer

(75) Inventor: Wataru Sasaki, Asaka (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/411,924

(22) Filed: Apr. 27, 2006

(30) Foreign Application Priority Data
May 10, 2005 (JP) 2005-137516

(51) Int. Cl. G09G 3/36

(52) U.S. Cl. 345/97

(57) ABSTRACT

The present invention provides a small and low-cost drive apparatus which prevents, when provided for a printer or display device, an image with contrast irregularity from being displayed or an image with contrast irregularity from being printed, and a printer provided with such a drive apparatus. Liquid crystal cells lining one-dimensionally of a liquid crystal cell array and signal output terminals of drivers are connected by wires which spread in a fan shape. Further, there are added two wires u and v adjacent to each other. The two wires u, v each have one end connected to corresponding one of two liquid crystal cells driven by neighboring drivers and the other end left unconnected. The two wires u, v extend at a predetermined distance therebetween from the two liquid crystal cells respectively.

### BACKGROUND OF THE INVENTION

1. Field of the Invention

The present invention relates to a drive apparatus provided with a one-dimensional array of driven cells and a drive unit which drives the driven cells, and to a printer provided with the drive apparatus.

2. Description of the Related Art

There are printers which record a color image on an instant film sheet. Among such printers, there is one that arranges liquid crystal shutters in a main scanning direction which is perpendicular to a sub scanning direction when cyclically irradiating an instant film sheet with the amount of light from a light-emitting element according to image data and irradiates the instant film sheet with the amount of light of each color while adjusting the shutter speeds of the liquid crystal shutters.

When many liquid crystal cells (which operate as shutters in the printer) are arranged on an apparatus such as printer in this way, drive units which drive the respective liquid crystal cells are indispensable, and therefore it is convenient for the apparatus side such as a printer that a driven unit made up of a-one-dimensional array of many liquid crystal cells and a drive unit for driving the driven unit be integrated into a drive apparatus on a glass substrate which also serves as electrodes of the liquid crystal cells not only from the standpoint of downsizing the apparatus but also from the standpoint of a mounting design of the interior of the apparatus (for example, see Japanese Patent Laid-Open No. 7-114036, Japanese Patent Laid-Open No. 10-339880).

In this way, when a drive apparatus is constructed with a drive unit mounted on a glass substrate which also serves as electrodes of the liquid crystal cells as a single unit, it is also important to consider the pitch of the array of liquid crystal cells and the pitch of many signal output terminals provided in the drive unit in addition to the arrangement of the respective liquid crystal cells and drive unit at such positions that pattern lengths between all the electrodes of the liquid crystal cells and signal output terminals of the drive unit become substantially the same.

Considering these points, if patterns are formed such that the driven unit and the drive unit are arranged at preferred positions on the glass substrate and all pattern lengths between the electrodes of the liquid crystal cells and signal output terminals of the drive unit become substantially the same, signals of uniform characteristics can be supplied from the drive unit to the driven unit.

FIG. 1 illustrates an example of a conventional drive apparatus 2.

Part (a) of FIG. 1 shows a top view of the drive apparatus 2 with a top case of the printer removed so as to expose the drive apparatus 2 provided for the printer and part (b) of FIG. 1 shows liquid crystal cells 2100 to 2136 of a liquid crystal cell array 21 which is a one-dimensional array and drivers 2a, 2b, which make up the drive apparatus 2, between which wiring patterns a1 to an and b1 to bn spread in a fan shape.

In the example shown in FIG. 1, since the pitch of the array of the liquid crystal cells 2100 to 2136 of the liquid crystal cell array 21 is on the order of a distance to realize a pixel corresponding to one dot on an instant film, and therefore the pitch of the array of the liquid crystal cells of the liquid crystal cell array 21 is considerably wider than the pitch of the signal output terminals of the drive units 2a, 2b. For this reason, in order to substantially equalize all wiring lengths of patterns connecting the drivers 2a, 2b and liquid crystal cell array 21, the one-dimensionally arranged liquid crystal cell array is divided into two or more groups G1, G2, the drive units 2a, 2b are provided for groups G1, G2 respectively, and further the lengths of connection patterns which spread in a fan shape between the respective signal output terminals of the drive units 2a, 2b and liquid crystal cells of the liquid crystal cell array 21 are designed to be substantially the same (same resistance value) using the technique of Japanese Patent Laid-Open No. 7-114036.

Furthermore, with reference to the techniques of Japanese Patent Laid-Open No. 7-114036 and Japanese Patent Laid-Open No. 10-339880, pattern widths are adjusted one by one so as to equalize the resistance values of the respective patterns, and further patterns are also formed with wiring distances that satisfy an inter-wire capacitance value which reduces the probability of occurrence of crosstalk to a predetermined value or below.

Furthermore, considering that patterns are formed in the wiring pattern as shown in part (b) of FIG. 1, in FIG. 1, the drivers 2a, 2b are provided which supply output signals having substantially the same characteristic to the respective one-dimensionally arranged liquid crystal elements and the drive apparatus 2 is constructed of those drivers 2a, 2b.

However, as shown in FIG. 1, when the respective signal output terminals of the drivers 2a, 2b and the respective liquid crystal cells are connected, the patterns in the neighboring central parts (indicated by reference numerals an, b1) of the two neighboring drivers 2a, 2b cannot be wired by any means with substantially the same wiring distances as other pattern distances.

In such a case, signals outputted from the drivers 2a, 2b designed beforehand so as to output signals taking account of influences of crosstalk are supplied to liquid crystal cells 2117, 2118 after passing through the patterns an, b1 without being affected by crosstalk, and therefore a difference is produced between the output signals supplied to the two liquid crystal cells 2117, 2118 and output signals supplied to the liquid crystal cells 2100 to 2116, 2119 to 2136 other than those liquid crystal cells.

For this reason, when the drive apparatus 2 is provided for the printer and display device or the like, there are problems that the display device displays hard-to-see images with contrast irregularity or the printer prints out hard-to-see images with contrast irregularity.

Thus, it is possible to change signal waveforms of drive signals supplied to the central liquid crystal cells 2117, 2118 beforehand taking account of such pattern wiring, but changing only the signal output terminals 2an, 2b1 where no influences of crosstalk appear requires measures such as adding a correction circuit in the vicinity of the signal output terminals 2an, 2b1 in the drive units 2a, 2b to be taken, which causes the sizes of the drivers 2a, 2b which are the drive units to increase and also increases the price.

### SUMMARY OF THE INVENTION

The present invention has been made in view of the above circumstances and provides a small and low-cost drive apparatus which prevents, when provided for a printer or display device, an image with contrast irregularity from being displayed or an image with contrast irregularity from being printed, and a printer to which such a drive apparatus is applied and which realizes downsizing.

The present invention provides a drive apparatus including:

a driven unit made up of a plurality of driven cells operating upon receiving a drive signal and lining one-dimensionally in a predetermined array direction with a first pitch;

a plurality of drive units which respectively take charge of a plurality of groups into which the plurality of driven cells are divided in the order of the array, the groups each including a plurality of driven cells, the drive units each having a plurality of signal output terminals that output drive signals for driving the plurality of driven cells in a group in charge thereof and that are arrayed with a second pitch which is narrower than the first pitch facing the driven unit, the number of the drive units being equal to the number of the groups;

a plurality of wires which respectively connect the plurality of driven cells in each of the groups of the driven unit to the plurality of signal output terminals in each of the drive units taking charge of the each of the groups, and which are spread from the each of the drive units toward the driven unit in a fan shape; and

two or more neighboring wires which each have one end connected to two driven cells driven by neighboring drive units and which extend at a predetermined distance therebetween or thereamong from the two driven cells, with the other end thereof left unconnected.

According to the drive apparatus of the present invention, two wires placed at the predetermined distance from each other are added, whereby a wiring distance substantially equivalent to the wiring distance of the two or more wires is also kept in the patterns an, b1 in the central part of the drive apparatus shown in FIG. 1.

Thus, effects of crosstalk also appear on the patterns an, b1 shown in FIG. 1 in the same way as for other parts to substantially the same degree as that of other patterns, whereby substantially the same signals as the signals supplied to the driven cells of other parts are also supplied to two neighboring driven cells driven by neighboring drive units.

In this way, when substantially the same signals are supplied from the drive units making up the drive apparatus of the present invention to the respective elements arrayed one-dimensionally on the driven unit side, it is possible to prevent, when the drive apparatus of the present invention is provided for a printer or display device or the like, an image with contrast irregularity from being displayed on a display screen or from being printed on a recording medium. Furthermore, the drive apparatus of the present invention can be manufactured with a simple change by only adding two wires to the conventional wires, and therefore it is possible to avoid upsizing of the drive apparatus, further realize a cost reduction of the drive apparatus or by extension cost reductions of a printer and display device or the like in which the drive apparatus is mounted.

In the drive apparatus according to invention, preferably, the two or more wires are two wires each having one end connected to corresponding one of the two driven cells and the other end thereof left unconnected,

a wire connecting a first driven cell which is one of the two driven cells to the drive unit is called a “first wire”, a wire connecting a third driven cell adjacent to the first driven cell which sandwiches the first driven cell with a second driven cell which is the other one of the two driven cells to the drive unit is called a “second wire”, a wire having one end connected to the first driven cell and the other end left unconnected is called a “third wire”, and a wire having one end connected to the second driven cell and the other end left unconnected is called a “fourth wire”, and

two wires consisting of the third wire and the fourth wire are wires that satisfy:
Lst/Dst=Luv/Duv
where Lst is the length of a portion where the second wire and first wire extend neighboring to each other, Dst is the distance between the second wire and the first wire of the portion where the second wire and the first wire extend neighboring to each other, Luv is the length of a portion where the third wire and the fourth wire extend neighboring to each other and Duv is the distance between the third wire and the fourth wire of the portion where the third wire and the fourth wire extend neighboring to each other.

This produces an effect as if the second wire, first wire, third wire and fourth wire were spaced uniformly and the second wire is placed between the first wire and third wire, which causes an effect of crosstalk similar to that of other wires to appear on the second wire. When the effect of crosstalk is given in the same way as to other parts, variations in the amplitude value of the drive signal supplied from the drive unit to the driven units are reduced, and when, for example, the driven unit is a liquid crystal cell, occurrence of contrast irregularity caused by variations in the amplitude value is suppressed.

Furthermore, the two or more wires may also extend from the two driven cells in an undulating shape at a predetermined distance from each other.

When wires are provided so as to extend at a predetermined distance from the two driven cells respectively with the other end of each wire left unconnected, the resistance value and inter-wire capacitance value may not exactly match the required values. In such a case, it is preferable to provide undulation to make the resistance value and capacitance value adjustable.

By so doing, no matter to what kind of apparatus including a display device or printer this drive apparatus may be applied, it is possible to obtain a desirable inter-wire capacitance value and resistance value by providing such undulation and adjusting the wiring length and distance and thereby display a clear image on a display screen or print a clear image on a recording medium such as a film.

When this drive apparatus is applied to such a printer, the driven cells correspond to liquid crystal cells which open/close upon receiving a drive signal and the drive unit corresponds to a driver which outputs a control signal that controls the opening/closing of the driven cells.

The present invention provides a printer which writes an image on a recording medium by means of light and is provided with a drive apparatus, the drive apparatus including:

a liquid crystal shutter unit made up of a plurality of liquid crystal cells operating upon receiving a drive signal and lining one-dimensionally in a predetermined array direction with a first pitch;.

a plurality of drive units which respectively take charge of a plurality of groups into which the plurality of driven cells are divided in the order of the array, the groups each including a plurality of driven cells, the drive units each having a plurality of signal output terminals that output drive signals for driving the plurality of driven cells in a group in charge thereof and that are arrayed with a second pitch which is narrower than the first pitch facing the driven unit, the number of the drive units being equal to the number of the groups;

a plurality of wires which respectively connect the plurality of driven cells in each of the groups of the driven unit to the plurality of signal output terminals in each of the drive units taking charge of the each of the groups, and which are spread from the each of the drive units toward the driven unit in a fan shape; and

two or more neighboring wires which each have one end connected to two driven cells driven by neighboring drive units and which extend at a predetermined distance therebetween or thereamong from the two driven cells, with the other end thereof left unconnected,

wherein an image is recorded on the recording medium by irradiating light which has passed through the liquid crystal cells making up the liquid crystal shutter unit onto the recording medium.

According to the printer of the present invention, it is possible to achieve downsizing of the printer by providing it with the drive apparatus of the present invention.

As explained so far, according to the present invention, it is possible to realize a small and low-cost drive apparatus which prevents, when provided for a printer or display device or the like, an image with contrast irregularity from being displayed or an image with contrast irregularity from being printed. Furthermore, mounting such a downsized drive apparatus inside the printer allows the size of the printer to be reduced, too.

### BRIEF DESCRIPTION OF THE DRAWINGS

FIG. 1 shows an example of a conventional drive apparatus 2;

FIG. 2 is a perspective view of a printer 1 provided with a drive apparatus of the present invention viewed from diagonally forward;

FIG. 3 shows how an instant film sheet in which an image is recorded based on image data from a camera-equipped cellular phone is ejected from the printer shown in FIG. 2;

FIG. 4 is a perspective view of the bottom side of the printer shown in FIG. 2 viewed from diagonally upward;

FIG. 5 is a perspective view of the printer shown in FIG. 4 with a film door 20 left open;

FIG. 6 is a block diagram showing a control system inside the printer;

FIG. 7 is a drawing corresponding to FIG. 1 and shows the structure of the drive apparatus 3010;

FIG. 8 shows a pattern formed on a glass substrate; and

FIG. 9 shows a modification example.

### DETAILED DESCRIPTION OF THE INVENTION

With reference now to the attached drawings, an embodiment of the present invention will be explained below.

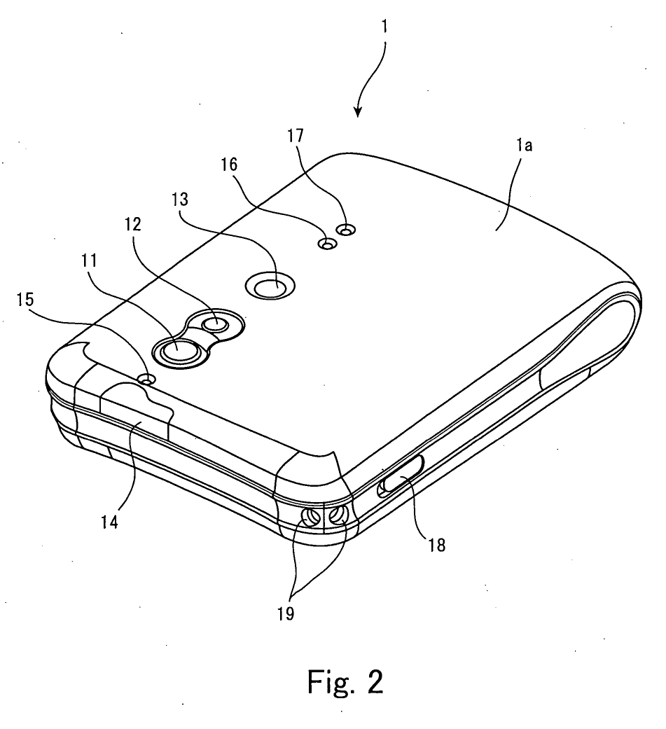

FIG. 2 is a perspective view of a printer 1 provided with the drive apparatus of the present invention viewed from diagonally forward.

This printer 1 is used in combination with a cellular phone or the like and designed such that an instant film pack made up of two or more (here 10) stacked instant film sheets in which a latent image is recorded by exposure to light and made visible through the development with a developer when the instant film sheet is ejected is loaded into a medium loading chamber, the instant film sheets are exposed to light in accordance with the image data and ejected and the developer is developed on the instant film sheet.

There are cellular phones capable of carrying out infrared-ray communication in compliance with IRDA (InfRared Data Association) and sending own information to other information apparatuses using this infrared-ray communication, and in the case of a camera-equipped cellular phone, it is possible to send image data to this printer 1.

When image data expressing an image captured by the camera-equipped cellular phone or image data sent to the cellular phone by mail or the like is transmitted to this printer 1 using an infrared-ray communication, this printer 1 records the image on the instant film sheet based on the image data and can also record an image again on another instant film sheet based on the transmitted image data through a simple operation of operating a repeat switch which will be described later without the user bothering to perform a retransmission from the cellular phone.

This printer 1 is a portable type printer having a thin, light and small structure as shown in FIG. 2 and has two built-in 3 V primary batteries. The instant film pack is loaded into a housing la of this printer 1 and an image is recorded in each of 10 stacked instant film sheets. In this embodiment, the drive apparatus is mounted inside the printer 1 of the present invention shown in FIG. 2 and the thin, light and small structure is thereby realized.

On the top surface of the housing la of the printer 1 are provided with operation buttons such as a power switch (hereinafter referred to as “power SW”) 11 which instructs powering ON/OFF of this printer 1 and a repeat switch (hereinafter referred to as “repeat SW”) 12 for recording an image again based on the transmitted image data. Furthermore, a counter 13 which indicates the number of remaining instant film sheets is provided on the top surface of the housing 1a. This counter 13 is a mechanical counter and when an instant film pack not in use is loaded, a count value “10” indicating that the number of remaining sheets is 10 is displayed. Hereinafter, every time an image is recorded on an instant film sheet, a numerical value indicating the number of remaining sheets decremented is displayed, and when an image is recorded on the tenth instant film sheet, a numerical value “0” indicating that the number of remaining sheets is 0 is displayed. When the instant film pack is removed, the counter is left blank, displaying nothing.

Furthermore, a transmission/reception section 14 which receives image data transmitted through the aforementioned infrared-ray communication and transmits a signal for informing the other party of the reception of the image data is provided at an end of the printer 1.

Furthermore, the housing la of this printer 1 is also provided with a power LED 15 which turns ON when power is turned ON and blinks during an infrared-ray communication, a communication error LED 16 which turns ON when an error occurs during an infrared-ray communication and a low-battery display LED 17 which turns ON to urge the user to replace the batteries when the voltage of the built-in batteries drops.

Furthermore, a film door opening switch 18 for opening a film door provided on the bottom side of the printer 1, which will be described later, is provided on one side of the printer 1 and strap holes 19 are provided in a corner.

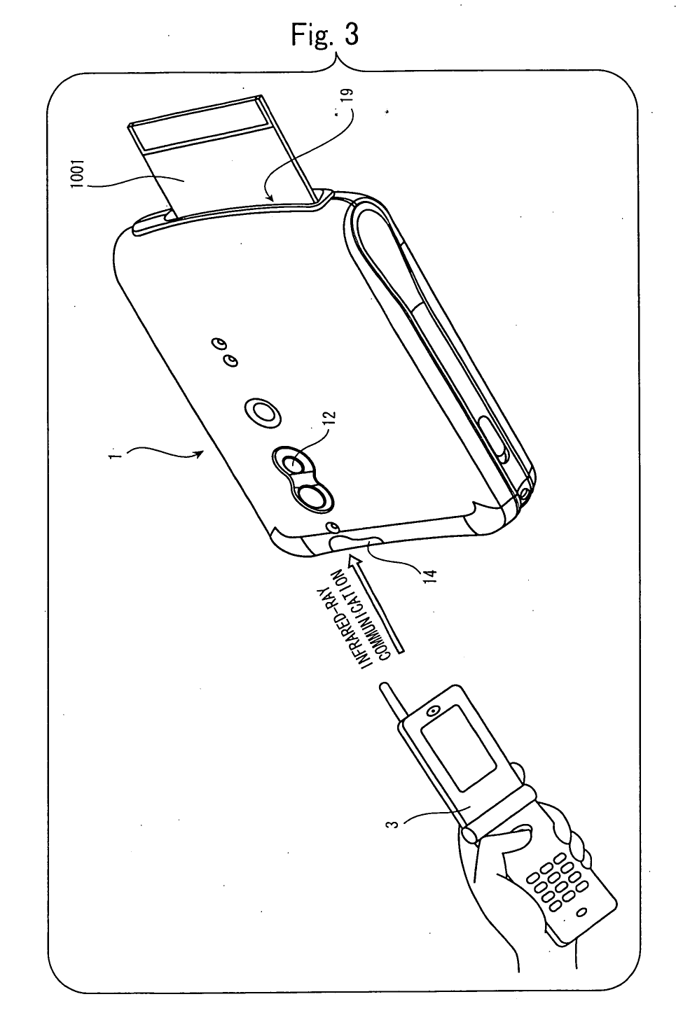

FIG. 3 shows how an instant film sheet on which an image is recorded based on image data from a camera-equipped cellular phone is ejected from the printer 1 shown in FIG. 2.

When the infrared-ray communication section of a camera-equipped cellular phone 3 is oriented toward the transmission/reception section 14 of the printer 1, the camera-equipped cellular phone 3 is operated to send image data expressing an image captured by the camera-equipped cellular phone 3 to the printer 1 using infrared-ray communication. The printer 1 receives the image data transmitted through the infrared-ray communication, records a latent image based on the received image data on the instant film sheet 1001 by exposure to light, and at the same time develops the instant film sheet 1001 and gradually ejects the instant film sheet from an outlet 19 of the printer 1. Afterwards, when the repeat SW12 (see FIG. 2) is operated, the same image is recorded again on another instant film sheet.

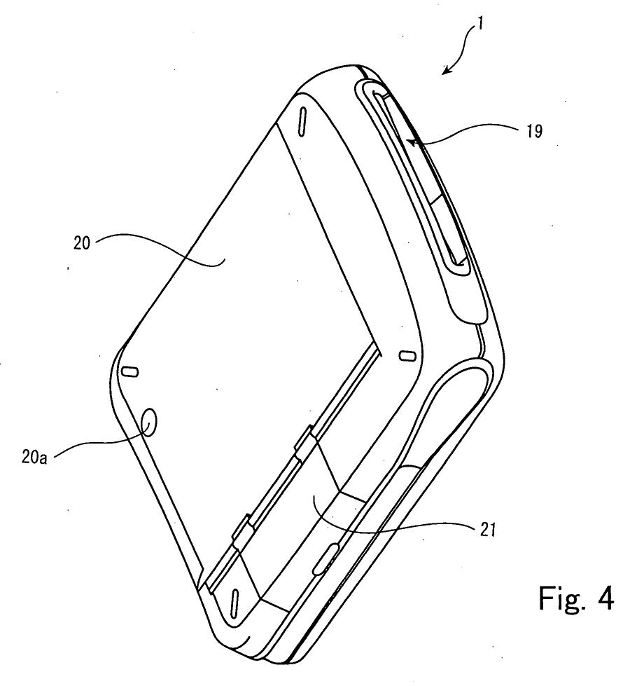

FIG. 4 is a perspective view of the bottom side of the printer 1 shown in FIG. 2 viewed from diagonally upward.

A film door 20 which is opened through operation of the film door opening switch 18 (see FIG. 2) is provided on the bottom side of the printer 1, this film door 20 is opened and an instant film pack is loaded in the medium loading chamber. Furthermore, the film door 20 is provided with a pack presence/absence confirmation window 20a to confirm the presence/absence of an instant film pack. A battery cover 21 which is opened to mount batteries serving as a power supply of this printer 1 is also provided adjacent to the film door 20.

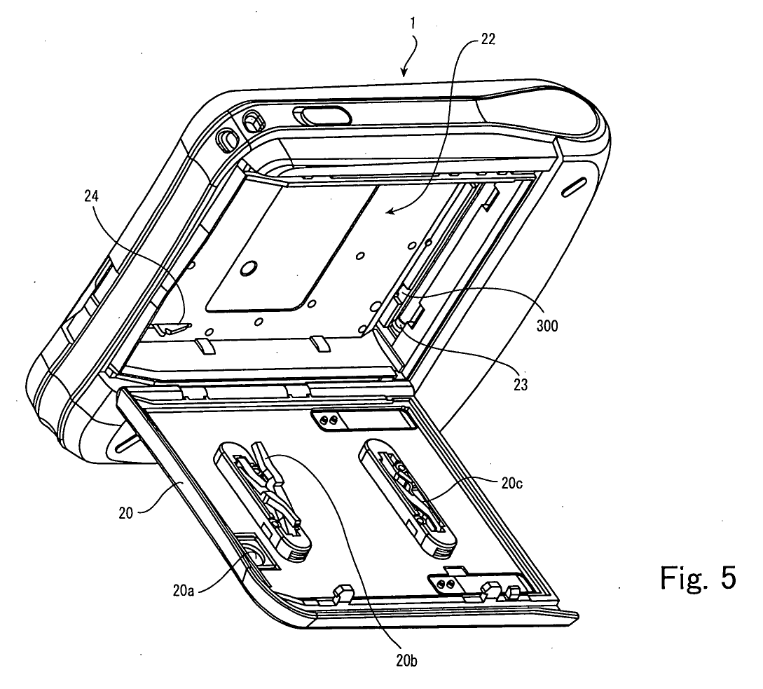

FIG. 5 is a perspective view of the printer 1 shown in FIG. 4 with the film door 20 left open.

The aforementioned pack presence/absence confirmation window 20a and spring members 20b, 20c are provided inside the film door 20 and these spring members 20b, 20c push the instant film sheets stacked in the instant film pack against the top side of the printer 1.

Furthermore, the printer 1 is also provided with a medium loading chamber 22 to load an instant film pack. An image writing section 300 furnished with the drive apparatus of the present invention and a transport roller 23 which constitutes a transport mechanism for transporting instant film sheets are provided next to the medium loading chamber 22 on the right side of FIG. 5. Furthermore, a claw 24 is provided at a lower position in the medium loading chamber 22 in FIG. 5 to send out an instant film sheet toward the image writing section 300 and transport roller 23. In such a structure, the top instant film sheet in the printer 1 out of the instant film sheets in the instant film pack is pushed up by the claw 24, transported by the transport roller 23 and recorded by the image writing section 300.

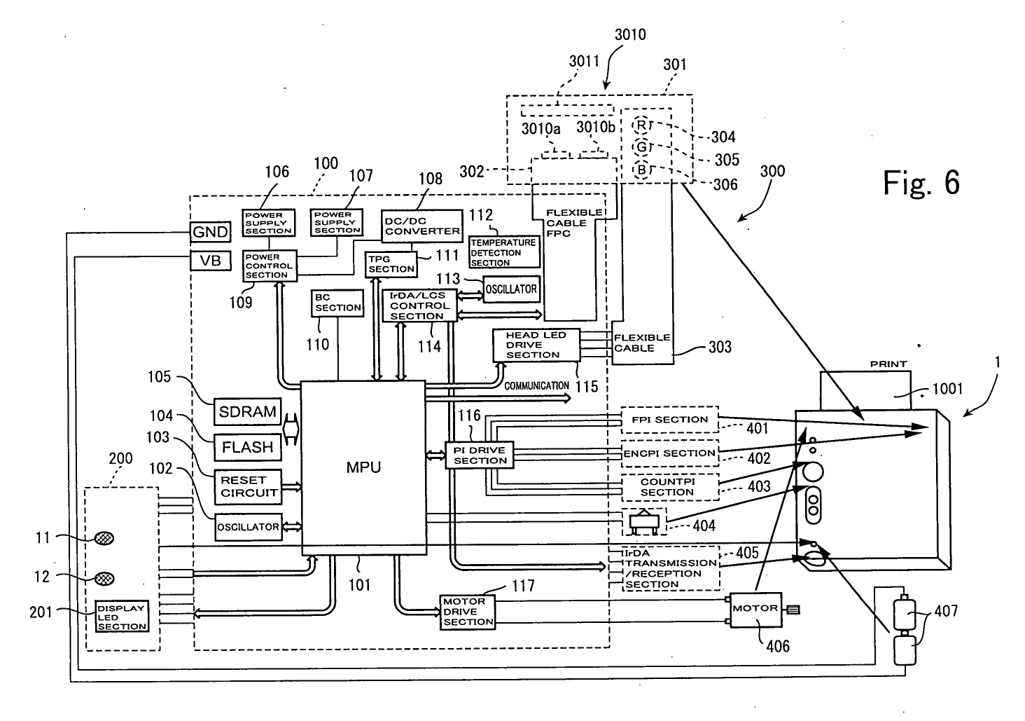

FIG. 6 is a block diagram showing the control system inside the printer.

A schematic view of the printer 1 shown in FIG. 2 is shown at the right end of FIG. 6 and the whole area except this right end section shows the configuration of the control system of this printer 1. Arrows shown in FIG. 6 show positional relationship among components of the control system in this printer 1.

This printer 1 is provided with: a main substrate section 100; a sub substrate section 200; an image writing section 300 provided with a drive apparatus 3010 including two drivers 3010a, 3010b which correspond to the plurality of drive units of the present invention; and a liquid crystal cell array 3011 which corresponds to the driven unit of the present invention; an FPI section 401; an ENCPI section 402; a COUNTPI section 403; a cam switch 404; an IrDA transmission/reception section 405 provided for the aforementioned transmission/reception section 14; and a motor 406. ADC motor is used as the motor 406.

The sub substrate section 200 is provided with the aforementioned power SW11, repeat SW12 and display LED section 201. The display LED section 201 is provided with the power LED 15, communication error LED 16, low-battery display LED 17 shown in FIG. 2 and a counter backlight LED (not shown) provided on the back of the counter 13.

The image writing section 300 is also provided with: an optical head section 301 including the liquid crystal cell array 3011 which operates as an optical guide or liquid crystal shutter (LCS); a flexible cable 302 which connects the drivers 3010a, 3010b, which are arranged on the glass electrode substrate of the liquid crystal cell array 3011 of the optical head section 301, and the main substrate section 100; and light-emitting elements (LEDs) 304, 305, 306 having light-emitting colors of red (R), green (G), blue (B) (these light-emitting elements form part of the optical head 301,and therefore FIG. 6 shows the respective light-emitting elements in the optical head 301) mounted in a flexible cable 303. As described above, the liquid crystal cell array 3011 in this image writing section 300 corresponds to the driven unit of the present invention, the two drivers 3010a, 3010b correspond to the drive units of the present invention, and the two drivers 3010a, 3010b and liquid crystal cell array 3011 constitute the drive apparatus 3010.

Though details will be described later, this image writing section 300 cyclically irradiates three color light rays of R, G, B from the LEDs 304, 305, 306 in synchronization with a write instruction pulse onto the instant film sheet being transported and thereby writes a latent image on the instant film sheet. Furthermore, the printer 1 incorporates two 3 V primary batteries 407.

Hereinafter, the main substrate section 100 will be explained. A 6 V supply voltage VB is applied to the main substrate section 100 from the primary batteries 407 connected in series. This main substrate section 100 is provided with an MPU (Micro Processor Unit) 101, an oscillator 102, a reset circuit 103, a flash memory (shown as “FLASH” in FIG. 6) 104 and an SDRAM 105.

The MPU 101 performs centralized control over the operation of this printer 1.

The oscillator 102 generates an oscillating signal of a predetermined frequency and supplies it to the MPU 101 as a clock signal.

The reset circuit 103 outputs a reset signal to initialize the MPU 101.

The flash memory 104 is a non-volatile memory and this flash memory 104 stores adjustment values for adjusting individual differences determined depending on the mechanism or the like specific to the printer 1.

The SDRAM 105 is a volatile memory and this SDRAM 105 stores image data or the like from the camera-equipped cellular phone 3.

Furthermore, this main substrate section 100 is provided with a power supply section 106 which inputs the 6 V supply voltage VB and outputs a 2.5 V voltage, a power supply section 107 which outputs a 3.3 V voltage and a DC/DC converter 108 which outputs a 15 V voltage. Furthermore, the main substrate section 100 is also provided with a power control section 109 which receives instructions from the MPU 101 and controls these power supply sections 106, 107 and DC/DC converter 108. Here, the 2.5 V voltage is supplied to the MPU 101 and the 3.3 V voltage is supplied to peripheral circuits other than the MPU 101. Furthermore, the 15 V voltage is used to drive LCDs, which will be described later.

This printer 1 is provided with the MPU 101 including a standby mode which is a low power consumption mode to extend the life of the primary batteries 407 and even when the power SW 12 is pushed, the MPU 101 enters the standby mode when the initialization processing ends. When an infrared-ray communication is performed from outside in this condition, the MPU 101 transitions from the standby mode to a normal operating mode, records an image on the instant film sheet and speedily transitions from the normal operating mode to the standby mode. Furthermore, even when the repeat SW 12 is pushed, the MPU 101 enters the standby mode after recording the image on the instant film sheet. Furthermore, the MPU 101 controls the power supply sections 106, 107, DC/DC converter 108 through the power control section 109 so that power is supplied to the respective sections only when necessary operations are performed. By so doing, it is possible to use this printer 1 with the built-in primary batteries 407 for a long period of time.

Furthermore, the main substrate section 100 is provided with a BC section 110, a TPG section 111, a temperature detection section 112, an oscillator 113, an IrDA/LCS control section 114 and a head LED drive section 115.

The BC section 110 checks to see whether or not the supply voltage VB of the primary batteries 407 falls below a predetermined value. The MPU 101 references this check result and when it decides that the supply voltage VB of the primary batteries 407 falls below the predetermined value, the MPU 101 turns ON the low-battery display LED 17 to urge the user to replace the batteries.

The TPG section 111 turns ON/OFF the 15 V voltage outputted from the DC/DC converter 108.

The temperature detection section 112 detects the temperature of the image writing section 300. The MPU 101 controls the opening/closing time or the like of each liquid crystal cell which operates here as a liquid crystal shutter of the liquid crystal cell array 3011 in the optical head section 301 according to the detected signal from this temperature detection section 112 by instructing it to the driver.

This liquid crystal cell array 3011 is placed on an optical path common to two or more color light rays emitted from the three LEDs 304, 305, 306 which are the light-emitting bodies mounted in the aforementioned flexible cable 303, opens/closes by a voltage applied between the electrodes of the respective liquid crystal cells of the liquid crystal cell array 3011 through the two drivers 3010a, 3010b after passing through the flexible cable 302 which is different from the flexible cable 303 under the control of the IrDA/LCS control section 114 in accordance with an instruction from the MPU 101 and controls irradiation of the color light rays onto the instant film sheet. The head LED drive section 115 which drives the three LEDs 304, 305, 306 mounted in the flexible cable 303 allows a current based on the instruction from the MPU 101 to flow-into the LEDs 304, 305, 306 through the flexible cable 303 and thereby drives those LEDs 304, 305, 306.

Furthermore, the IrDA/LCS control section 114 for controlling the liquid crystal cell array 3011 controls the IrDA transmission/reception section 405 and optical head section 301 based on an oscillating signal from the oscillator 113. The IrDA transmission/reception section 405 is provided with a light projecting element and light receiving element to realize an infrared-ray communication and the IrDA/LCS control section 114 sends data photoelectrically converted by the light receiving element to the MPU 101 or sends data from the MPU 101 to inform it to external devices through the light projecting element. Furthermore, the IrDA/LCS control section 114 applies a voltage between the electrodes of the liquid crystal cells of the liquid crystal cell array 3011 through the flexible cable 302 and then the driver under an instruction from the MPU 101 and controls the opening/closing of each liquid crystal cell according to the image data.

When causing the IrDA/LCS control section 114 to control the opening/closing of each liquid crystal cell of the liquid crystal cell array 3011 which serves as this liquid crystal shutter (LCS), the MPU 101 receives an encoder signal from the ENCPI section 402, directly supplies the encoder signal to the IrDA/LCS control section 114 so as to control the opening/closing of each liquid crystal cell of the liquid crystal cell array 3011. While the IrDA/LCS control section 114 is controlling the opening/closing of each liquid crystal cell of the liquid crystal cell array 3011, the MPU 101 causes the head LED drive section 115 to perform control so as to sequentially turn ON the LEDs 304, 305, 306 in two or more colors per one write instruction pulse and keep the LEDs 304, 305, 306 tuned OFF for a standby period after one cycle of turning ON of color light rays in the two or more colors completes until the next write instruction pulse.

As explained above, the printer 1 of this embodiment sends an instant film sheet in a predetermined sub scanning direction (direction in which the instant film sheet is sent out) using the motor 406, cyclically irradiates three color light rays of R, G, B onto the instant film sheet, simultaneously writes the same color into all pixels lining in the main scanning direction which crosses the sub scanning direction, records a latent image based on the image data on the instant film sheet 1001 through exposure to light, develops the image on the instant film sheet 1001 and gradually ejects the instant film sheet from the outlet 19 of the printer 1.

When recording the latent image on the instant film sheet, as described above, the MPU 101 causes the head LED drive section 115 to control turning ON of the LEDs 304, 305, 306 provided for the flexible cable 303 and at the same time causes the IrDA/LCS control section 114 to open/close each liquid crystal cell of the liquid crystal cell array 3011 which operates as the liquid crystal shutter according to an image signal, sequentially irradiates the respective color light rays onto the instant film sheet and thereby records the latent image on the entire instant film sheet.

Here, the structure of the drive apparatus 3010 in the image writing section 300 according to the present invention will be explained.

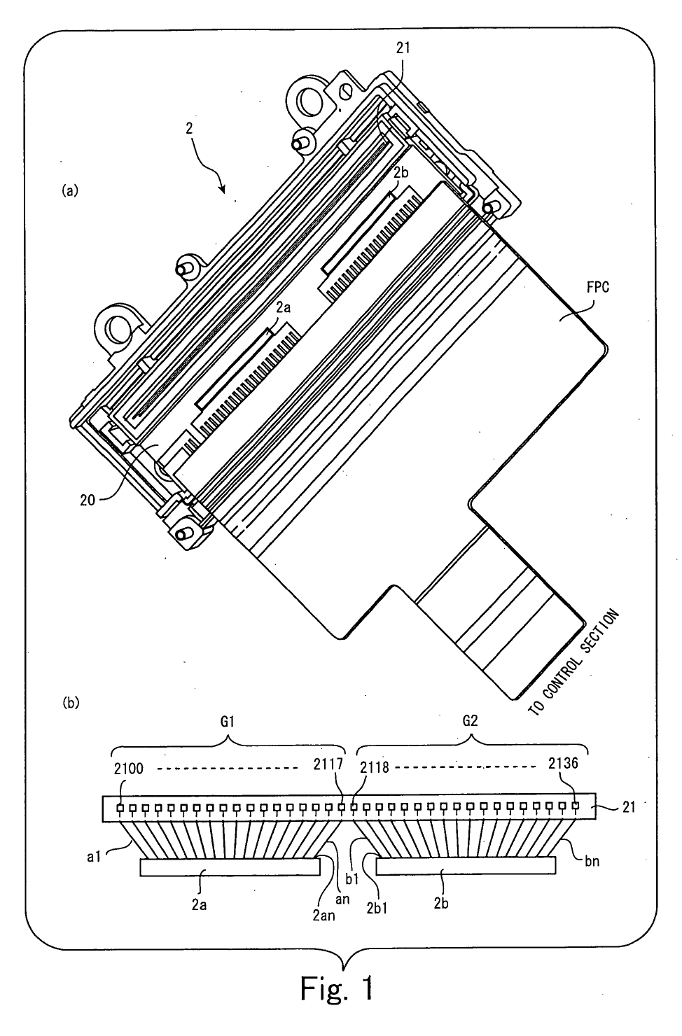

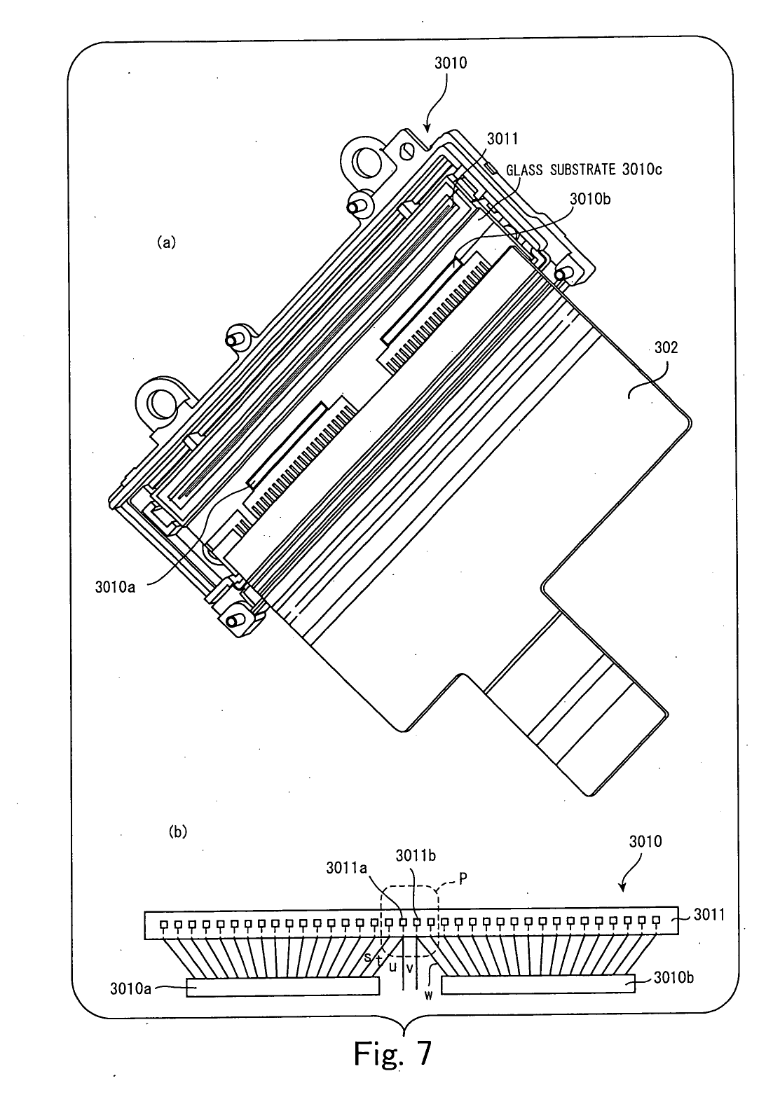

FIG. 7 is a figure corresponding to FIG. 1 and shows the structure of the drive apparatus 3010 incorporated in the printer 1 of the present invention.

Part (a) of FIG. 7 is a top view of the drive apparatus 3010 with the top case of the printer 1 removed so as to expose the drive apparatus 3010 mounted in the printer 1 and part (b) of FIG. 7 shows wiring patterns spreading in a fan shape between the respective liquid crystal cells of the liquid crystal cell array 3011 which is a one-dimensional array making up the drive apparatus 3010 and the signal output terminals of the drivers 3010a, 3010b.

As shown in part (b) of FIG. 7, this is completely identical to the construction in FIG. 1 except in that two wires u, v are added to the one shown in part (b) of FIG. 1.

As explained with reference to FIG. 1, when the signal output terminals provided for the drivers 3010a, 3010b are connected to their respective liquid crystal cells in such a way as to spread in a fan shape, the problem is that it is not possible by any means to perform wiring with substantially the same wiring distance as other pattern distances for the patterns in the neighboring central parts (areas shown by reference characters t, w) of the two neighboring drivers 3010a, 3010b. Thus, this embodiment additionally forms two wires u, v in a central area P as shown in part (b) of FIG. 7.

By so doing, influences of crosstalk appear on the wires u, v in the same way as the rest of parts as if a signal were transmitted on the two unconnected wires u, v.

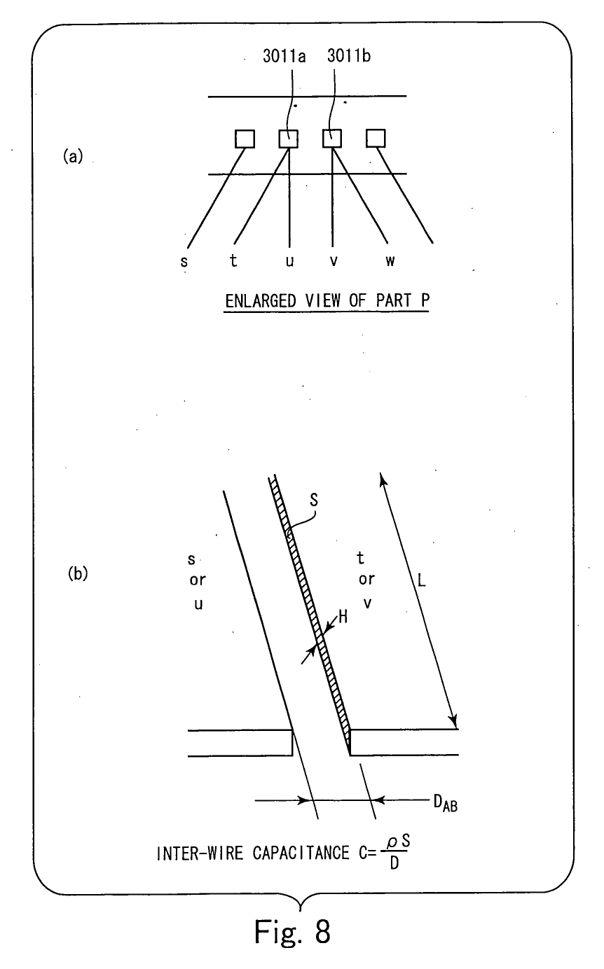

Here, when additional wiring is performed in addition to the wring in FIG. 1, an example showing how a wiring distance D and wiring length L of the two additional wires u, v are determined will be explained with reference to FIG. 8.

FIG. 8 shows wiring patterns formed on the glass substrate 3010c (see part (a) of FIG. 7).

Part (a) of FIG. 8 shows an enlarged view of the wiring patterns u, v, s, t, w in the central area P in part (b) of FIG. 7 and part (b) of FIG. 8 shows a conductor thickness H and wiring length L of mutually opposed wiring patterns.

As publicly known, an inter-wire capacitance C can be calculated by the following expression.
Inter-wire capacitance C=ρ÷D=ρHL+D Expression 1 (ρ: dielectric constant)

For example, by calculating a capacitance Cst between pattern s and pattern t, inter-wire capacitance Cut between pattern u and pattern t out of the two added patterns u, v and inter-wire capacitance Cuv between pattern u and pattern v from Expression 1 and further adding wires so as to satisfy Expression 2 below, it is possible to add wires as if all wires were spaced uniformly.
Cst+Cut≈Cut+Cuv Expression 2

However, since the wiring between pattern t and pattern u is diagonal, if the length and wiring distance are modified so as to satisfy a relationship:
Lst/Dst≈Luv/Duv Expression 3
where Dst is the distance between pattern s and pattern t, Duv is the distance between pattern u and pattern v, Luv is the wiring lengths of both patterns u, v and Lst is the wiring length common to both patterns s, t, the distance between two wires Duv and wiring length Luv are correctly determined.

The relationship in Expression 3 is not dedicatedly used for the two wires u, v, but used to determine the wiring distance D and wiring length L of all other wires. In other words, if an attempt is made to perform all wiring with one driver instead of placing two or more drivers, the relationship in Expression 3 no longer holds for all wires, and therefore two or more drivers are arranged so as to allow the relationship in Expression 3 to hold for all wires and make all wire lengths and wiring distances substantially identical.

When two wires u, v are added in this way, substantially the same signal is supplied to the respective liquid crystal cells, preventing the occurrence of contrast irregularity.

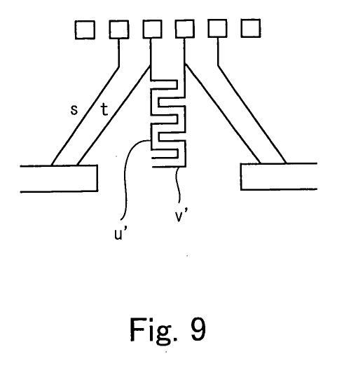

FIG. 9 shows a modification example.

When wiring is performed linearly as shown in FIG. 9, the resistance value may increase compared to other parts. In such a case, it is preferable to form two wires u′ and v′ using undulation and slightly increase the resistance values of the wiring patterns. By so doing, it is possible to adjust not only the resistance value but also the capacitance value with undulation, and thereby give substantially the same effect of crosstalk as that of other parts to the two patterns respectively.

The embodiment described above has explained the case where two drivers are provided, but three or more drivers may also be provided.

What is claimed is:

1. A drive apparatus comprising:
a driven unit made up of a plurality of driven cells operating upon receiving a drive signal and lining one-dimensionally in a predetermined array direction with a first pitch;
a plurality of drive units which respectively take charge of a plurality of groups into which the plurality of driven cells are divided in the order of the array, the groups each including a plurality of driven cells, the drive units each having a plurality of signal output terminals that output drive signals for driving the plurality of driven cells in a group in charge thereof and that are arrayed with a second pitch which is narrower than the first pitch facing the driven unit, the number of the drive units being equal to the number of the groups;
a plurality of wires which respectively connect the plurality of driven cells in each of the groups of the driven unit to the plurality of signal output terminals in each of the drive units taking charge of the each of the groups, and which are spread from the each of the drive units toward the driven unit in a fan shape; and
two or more neighboring wires which each have one end connected to two driven cells driven by neighboring drive units and which extend at a predetermined distance therebetween or thereamong from the two driven cells, with the other end thereof left unconnected.

2. The drive apparatus according to claim 1,
wherein the two or more wires are two wires each having one end connected to corresponding one of the two driven cells and the other end thereof left unconnected,
a wire connecting a first driven cell which is one of the two driven cells to the drive unit is called a “first wire”, a wire connecting a third driven cell adjacent to the first driven cell which sandwiches the first driven cell with a second driven cell which is the other one of the two driven cells to the drive unit is called a “second wire”, a wire having one end connected to the first driven cell and the other end left unconnected is called a “third wire”, and a wire having one end connected to the second driven cell and the other end left unconnected is called a “fourth wire”, and
two wires consisting of the third wire and the fourth wire are wires that satisfy:
Lst/Dst=Luv/Duv
where Lst is the length of a portion where the second wire and first wire extend neighboring to each other, Dst is the distance between the second wire and the first wire of the portion where the second wire and the first wire extend neighboring to each other, Luv is the length of a portion where the third wire and the fourth wire extend neighboring to each other and Duv is the distance between the third wire and the fourth wire of the portion where the third wire and the fourth wire extend neighboring to each other.

3. The drive apparatus according to claim 1,
wherein the two or more wires extend from the two driven cells in an undulating shape at a predetermined distance from each other.

4. The drive apparatus according to claim 1,
wherein the driven cells are liquid crystal cells which open/close upon receiving a drive signal and the drive unit outputs a control signal that controls the opening/closing of the driven cells.

5. A printer which writes an image on a recording medium by means of light and is provided with a drive apparatus, the drive apparatus comprising:
a liquid crystal shutter unit made up of a plurality of liquid crystal cells operating upon receiving a drive signal and lining one-dimensionally in a predetermined array direction with a first pitch;
a plurality of drive units which respectively take charge of a plurality of groups into which the plurality of driven cells are divided in the order of the array, the groups each including a plurality of driven cells, the drive units each having a plurality of signal output terminals that output drive signals for driving the plurality of driven cells in a group in charge thereof and that are arrayed with a second pitch which is narrower than the first pitch facing the driven unit, the number of the drive units being equal to the number of the groups;
a plurality of wires which respectively connect the plurality of driven cells in each of the groups of the driven unit to the plurality of signal output terminals in each of the drive units taking charge of the each of the groups, and which are spread from the each of the drive units toward the driven unit in a fan shape; and
two or more neighboring wires which each have one end connected to two driven cells driven by neighboring drive units and which extend at a predetermined distance therebetween or thereamong from the two driven cells, with the other end thereof left unconnected,
wherein an image is recorded on the recording medium by irradiating light which has passed through the liquid crystal cells making up the liquid crystal shutter unit onto the recording medium.
